(19) United States
(12) Patent Application Publication
(10) Pub. No.: US 2018/0022504 A1
(43) Pub. Date: Jan. 25, 2018

(54) BAMBOO BOWL AND PRODUCTION PROCESS THEREOF

(71) Applicant: Fujian Shuangyi Bamboo and Wood Development Co., Ltd, NANPING (CN)

(72) Inventor: ZHISHENG LI, NANPING (CN)

(73) Assignee: Fujian Shuangyi Bamboo and Wood Development Co., Ltd

(21) Appl. No.: 15/657,140

(22) Filed: Jul. 22, 2017

(30) Foreign Application Priority Data
Jul. 22, 2016 (CN) 201610581814.8

(51) Int. Cl. B65D 6/00; B27M 3/24; B27M 1/08; B65D 8/00

(52) U.S. Cl. CPC B65D 9/32; B65D 9/02; B27M 3/24; B27M 1/08

(57) ABSTRACT

A production process of a bamboo bowl includes: cutting out arc-shaped bamboo strips on a bamboo board; splicing the bamboo strips into a bamboo ring; finally gluing several bamboo rings with gradually larger diameters on the bottom of the bamboo bowl successively to form a bamboo bowl billet, and making into a bamboo bowl after subsequent processings. The bamboo bowl made by the above production process includes a bamboo bowl bottom and bamboo rings superimposed on the bamboo bowl bottom; the bamboo ring consists of at least two arc-shaped bamboo strips, the diameters of the bamboo rings are gradually increased from the bottom up; the arc-shaped bamboo strips are fixed through adhesive, and the bamboo rings are also fixed through adhesive.

### CROSS-REFERENCE TO RELATED APPLICATIONS

This application claims priority to Chinese Patent Application No. 201610581814.8 with a filing date of Jul. 22, 2016. The content of the aforementioned applications, including any intervening amendments thereto, are incorporated herein by reference.

### TECHNICAL FIELD

The present invention relates to the field of bamboo bowl production, and in particular, to a bamboo bowl and production process thereof.

### BACKGROUND OF THE PRESENT INVENTION

A bamboo bowl is a kind of bamboo furniture, and is widely loved by modern people due to its numerous advantages such as immaculacy, simplicity and environmentally friendly materials. In the production process of the bamboo bowl, usually, bamboo loops are directly cut out on a bamboo board, and then are superimposed to make into a bamboo bowl. However, in the existing production process, not only the efficiency of cutting bamboo loops is low, but also the utilization factor of bamboo boards is not high, which imperceptibly increases production costs of enterprises.

### SUMMARY OF PRESENT INVENTION

In order to solve the above problems, the present invention provides a bamboo bowl and production process thereof capable of increasing the production efficiency, taking full advantage of bamboo boards and reducing the production cost of enterprises.

The first technical solution of the present invention is as follows. A production process of a bamboo bowl includes: cutting out arc-shaped bamboo strips on a bamboo board; splicing the bamboo strips into a bamboo ring; finally gluing several bamboo rings with gradually larger diameters on the bottom of the bamboo bowl successively to form a bamboo bowl billet, and making into a bamboo bowl after subsequent processings. The process includes the following detailed steps:

(1) preparing bamboo strips: slitting mao bamboo, then grinding and carbonizing the bamboo strips;

(2) preparing a bamboo board: gluing and laminating the processed bamboo strips in step (1) to form the bamboo board;

(3) cutting the bamboo board: measuring a width of the bamboo board to determine the number of arc-shaped bamboo strips required to enclose one bamboo ring; calculating a radius of the arc-shaped bamboo strip by a geometric calculation formula; then cutting the bamboo board according to this radius; the width of the cut arc-shaped bamboo strips is between 0.5-4 cm, a snap slot is cut out at one end of the arc-shaped bamboo strip and a snap strip matched with the snap slot is cut out at the other end thereof;

(4) polishing arc-shaped bamboo strips: conducting polish on a sanding polisher according to prescribed specifications, such that the arc-shaped bamboo strips have equal thickness and width;

(5) combining into a bowl: combining the arc-shaped bamboo strips into a ring from small to large in radius using adhesive; then superimposing the arc-shaped bamboo strips from the bottom up in an increasing order in radius, the number of layers, of the superimposed bamboo rings ranging from 6 to 12; the bamboo bottom being a round solid bamboo board; combining into a bamboo bowl billet finally;

(6) post processing; polishing an inter surface and an outer surface of the bamboo bowl billet into smooth curved surfaces; then performing carving and paint spraying.

The second technical solution of the present invention is as follows. A production process of a bamboo bowl includes: bending a bamboo board into an arc shape in its width direction using a bamboo board bending technique; then cutting the arc-shaped bamboo board into arc-shaped bamboo strips in its length direction; splicing the arc-shaped bamboo strips into a bamboo ring; finally gluing several bamboo rings with gradually larger diameters on the bottom of the bamboo bowl successively to form a bamboo bowl billet, and making into a bamboo bowl after subsequent processings. This method contributes to further increasing the production efficiency and reducing waste materials of the bamboo board in cutting.

The third technical solution of the present invention is as follows. A production process of a bamboo bowl includes: gluing and superimposing successively a plurality of single bamboo boards, and bend molding the bamboo boards on a special shape molding machine to make into an arc-shaped bamboo board; then cutting the arc-shaped bamboo board into arc-shaped bamboo strips in its length direction: splicing the arc-shaped bamboo strips into a bamboo ring; finally gluing several bamboo rings with gradually larger diameters on the bottom of the bamboo bowl successively to form a bamboo bowl billet, and making into a bamboo bowl after subsequent processings. Compared with the second technical solution, the third technical solution facilitates further reduction in the difficulty of the arc-shaped bamboo board production and increase in the production efficiency.

The bamboo bowl made using the above production process of a bamboo bowl includes a round solid bamboo board bowl bottom and bamboo rings superimposed on the bowl bottom; the bamboo ring consists of at least two arc-shaped bamboo strips, the diameters of the bamboo rings are gradually increased from the bottom up; the arc-shaped bamboo strips are fixed through, adhesive, and the bamboo rings are also fixed through adhesive.

In the bamboo bowl producing process of the present invention, the arc-shaped bamboo strips are produced firstly by using the bamboo board or single bamboo boards, and then are spliced into a bamboo ring, which can solve the problem of low utilization factor caused by directing cutting out bamboo rings on the bamboo board, increase the production efficiency, and reduce the production cost. The produced bamboo bowl has an aesthetic structure, and excellent sealing performance, which improves product qualities and contributes to selling.

### DESCRIPTION OF THE DRAWINGS

FIG. 1 is a schematic diagram of cutting the bamboo board.

FIG. 2 is a sectional view of the bamboo bowl.

FIG. 3 is a structural schematic diagram of the arc-shaped bamboo strip of the bamboo bowl.

FIG. 4 is a structural schematic diagram of a quartered bamboo ring.

FIG. 5 is a structural schematic diagram of a trisection bamboo ring.

FIG. 6 is a structural schematic diagram of a bamboo ring with six equal sections.

### DETAILED DESCRIPTION OF PREFERRED EMBODIMENTS

In order to better set forth the present invention, the present invention will be explained below in detail in combination with the embodiments.

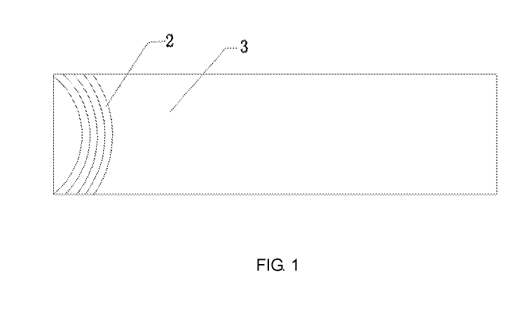

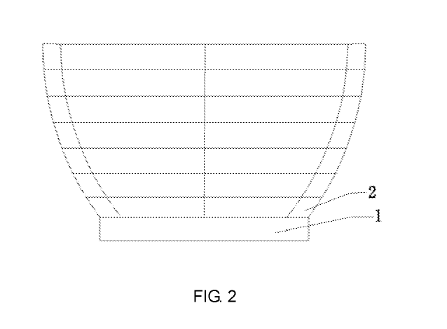

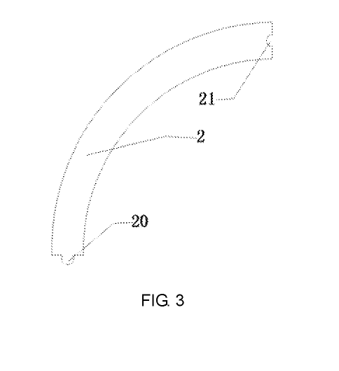

As shown in FIGS. 1-6, a production process of a bamboo bowl includes the following steps:

(1) preparing bamboo strips: slitting mao bamboo, then grinding and carbonizing the bamboo strips;

(2) preparing a bamboo board: gluing and laminating the processed bamboo strips in step (1) to form the bamboo board 3;

(3) cutting the bamboo board: measuring a width of the bamboo board 3 to determine the number of arc-shaped bamboo strips 2 required to enclose one bamboo ring; calculating a radius of the arc-shaped bamboo strip by a geometric calculation formula; then cutting the bamboo board according to this radius.

Specifically, it is assumed that the width of the bamboo board 3 is d.

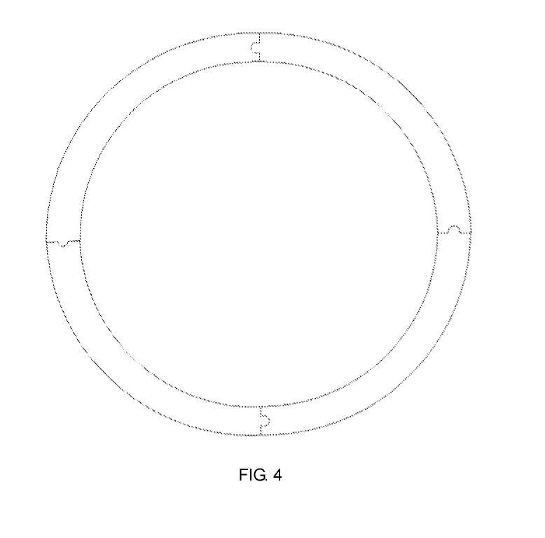

As shown in FIG. 4, when the number of the arc-shaped bamboo strips 2 required to enclose one bamboo ring is four, the radius of the arc-shaped bamboo strip equals d/1.414 according to the geometric formula,

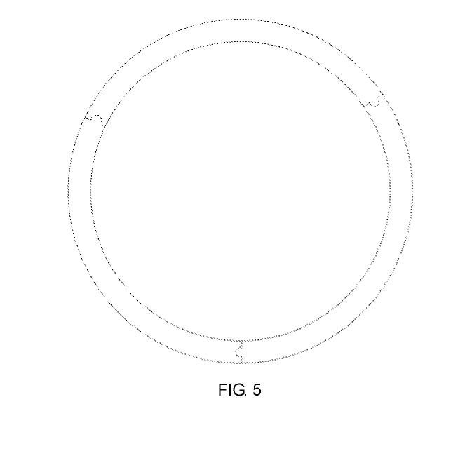

As shown in FIG. 5, when the number of the arc-shaped bamboo strips 2 required to enclose one bamboo ring is three, the radius of the arc-shaped bamboo strip equals d/1.732 according to the geometric formula.

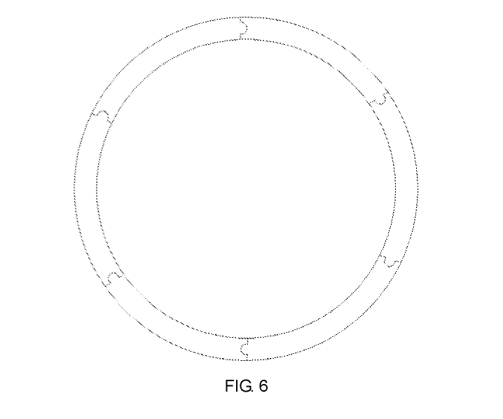

As shown in FIG. 6, when the number of the arc-shaped bamboo strips 2 required to enclose one bamboo ring is six, the radius of the arc-shaped bamboo strip equals d according to the geometric formula.

The width of the arc-shaped bamboo strip ranges from 0.5 to 4 cm. The snap slot 21 is cut out at one end of the arc-shaped bamboo strip and a snap strip 20 matched with the snap slot 21 is cut out at the other end thereof.

The production process of a bamboo bowl further includes:

(4) polishing arc-shaped bamboo strips: conducting polish on a sanding polisher according to prescribed specifications, such that the arc-shaped bamboo strips have equal thickness and width;

(5) combining into a bowl: combining the arc-shaped bamboo strips 2 into a ring from small to large in radius using adhesive; then superimposing the arc-shaped bamboo strips from the bottom up in an increasing order in radius, the number of layers of the superimposed bamboo rings ranging from 6 to 12; the bamboo bottom 1 being a round solid bamboo board; combining into a bamboo bowl billet finally;

(6) post processing: polishing an inter surface and an outer surface of the bamboo bowl billet into smooth curved surfaces; then performing carving and paint spraying.

The bamboo bowl produced according to the above method includes a bowl bottom 1 and bamboo rings superimposed on the bowl bottom 1; the bamboo ring consists of several arc-shaped bamboo strips 2, the diameters of the bamboo rings are gradually increased from the bottom up; the arc-shaped bamboo strips 2 are fixed through adhesive, and the bamboo rings are also fixed through adhesive. Specifically, the width of the cut arc-shaped bamboo strip is between 0.5-4 cm. The snap slot 21 is cut out at one end of the arc-shaped bamboo strip 2 and the snap strip 20 matched with the snap slot 21 is cut out at the other end thereof. The number of bamboo rings is 6 to 12.

The above embodiments are not taken as further limits to the present invention. Non-material modifications to the contents of the present invention made by persons skilled in the art shah fall within the protection scope of the present invention.

I claim:

1. A production process of a bamboo bowl, comprising cutting out arc-shaped bamboo strips on a bamboo board; splicing the bamboo strips into a bamboo ring; finally gluing several bamboo rings with gradually larger diameters on the bottom of the bamboo bowl successively to form a bamboo bowl billet, and making into a bamboo bowl after subsequent processings.

2. The production process of a bamboo bowl according to claim comprising the following steps:
(1) cutting the bamboo board: measuring a width of the bamboo board to determine the number of arc-shaped bamboo strips required to enclose one bamboo ring; calculating a radius of the arc-shaped bamboo strip; then cutting out the arc-shaped bamboo strips on the bamboo board according to this radius value;
(2) polishing arc-shaped bamboo strips: conducting polish on a sanding polisher according to prescribed specifications, such that the arc-shaped bamboo strips have equal thickness and width;
(3) combining into a bowl: combining the arc-shaped bamboo strips into a ring from small to large in radius using adhesive; then superimposing the arc-shaped bamboo strips from the bottom up in an increasing order in radius; the bamboo bottom being a round solid bamboo board; combining into a bamboo bowl billet finally;
(4) post processing: polishing an inter surface and an outer surface of the bamboo bowl billet into smooth curved surfaces; then performing carving and paint spraying.

3. The production process of a bamboo bowl according to claim 2,
wherein one end of the arc-shaped bamboo strip is provided with a snap slot and the other end thereof is provided with a snap strip.

4. A production process of a bamboo bowl, comprising bending a bamboo board into an arc shape in its width direction using a bamboo board bending technique; then cutting the arc-shaped bamboo board into arc-shaped bamboo strips in its length direction: splicing the arc-shaped bamboo strips into a bamboo ring; finally gluing several bamboo rings with gradually larger diameters on the bottom of the bamboo bowl successively to form a bamboo bowl billet, and making into a bamboo bowl after subsequent processings.

5. A production process of a bamboo bowl, comprising gluing and superimposing successively a plurality of single bamboo boards, and bend molding the bamboo boards on a profiled make-up machine to make into an arc-shaped bamboo board; then cutting the arc-shaped bamboo board into arc-shaped bamboo strips in its length direction; splicing the arc-shaped bamboo strips into a bamboo ring; finally gluing several bamboo rings with gradually larger diameters on the bottom of the bamboo bowl successively to form a bamboo bowl billet, and making into a bamboo bowl after subsequent processings.

6. A bamboo bowl made by the production process according to claim 1, comprising a bamboo bowl bottom and bamboo rings superimposed on the bamboo bowl bottom; the bamboo ring consists of at least two arc-shaped bamboo strips, the diameters of the bamboo rings are gradually increased from the bottom up.

7. A bamboo bowl made by the production process according to claim 5, comprising a bamboo bowl bottom and bamboo rings superimposed on the bamboo bowl bottom; the bamboo ring consists of at least two arc-shaped bamboo strips, the diameters of the bamboo rings are gradually increased from the bottom up.
